(19) United States
(12) Patent Application Publication
(10) Pub. No.: US 2004/0258589 A1
(43) Pub. Date: Dec. 23, 2004

(54) Method and apparatus for crystal growth

(76) Inventor: Gregory W. Golovanoff, Fort Collins, CO (US)

Correspondence Address: ANCEL W. LEWIS, JR., 425 WEST MULBERRY, SUITE 101, FORT COLLINS, CO, 80521, US

(21) Appl. No.: 10/873,349

(22) Filed: Jun. 22, 2004

Related U.S. Application Data
(60) Provisional application No. 60/480,568, filed on Jun. 23, 2003.

(51) Int. Cl. B01D 9/00

(52) U.S. Cl. 422/245.1

(57) ABSTRACT

Apparatus for sugar crystallization includes a vessel with a calandria in the vessel and a downdraft tube extending up from the downtake of the calandria. A method for sugar crystallization includes feeding solution into a crystallizer, supersaturating the solution to a chosen level, adding seed crystals with a chosen crystal size distribution to the solution, and progressive increasing the growth rate of the crystals according to a growth rate profile. The growth rate is adjusted to maintain the growth rate profile by in-situ measurement of the crystal size distribution.

This application claims the benefit under 35 U.S.C. § 119(e) of the U.S. provisional patent application No. 60/480,568 filed Jun. 23, 2003.

### TECHNICAL FIELD

The present invention relates to crystallization and more particularly to a method and apparatus for crystallization that follows a theoretical growth rate profile based on available area for salute deposition from solution.

### BACKGROUND ART

In sugar production, a solution of substantially sucrose and water, commonly know as standard liquor, is fed into a vacuum pan or crystallizer for crystallization. The crystallizer is generally a tank or closed vessel, often a vertical cylindrical shape, with a heat exchanger known as calandria inside. The calandria is generally located at a selected height near the bottom of the crystallizer and includes a plurality of vertical tubes that the solution flows up through. A downtake through the center of the calandria and an impeller in the bottom of the crystallizer are provided for circulation of solution in the crystallizer. The crystallizer is airtight and connected to a vacuum source.

In prior known methods, an initial charge of solution, that extends 8″ to 12″ above the calandria, is fed into the crystallizer. Steam fed through the calandria boils the solution. Such a low volume initial charge, where the calandria occupies the major volume of the solution, can cause high temperature gradients, localized evaporation, and poor homogeneity. The vacuum allows the solution to evaporate while the solution is maintained below about 85° C., avoiding the sugar degradation and color formation that are created by temperatures higher than 85° C. The solution is evaporated until a selected ratio of supersaturation is reached. A population of seed crystals is then introduced into the solution, initiating crystal growth.

In sugar crystallization, the process of crystal growth continues with addition of solution over time, to a final volume significantly above the level of the initial charge, and continued evaporation of water. The fluidity of the mixture of crystals and solution, known as massecuite, continuously decreases as the crystal content of the massecuite increases. The process is stopped before the fluidity increases to a point where the massecuite will not flow from the crystallizer. In prior known crystallizers, where the level of the final volume is significantly above the calandria, the solution flowing out of the calandria tubes near the downtake tends to shortcut back down the downtake, leading to poor homogeneity in the solution.

Crystal growth rate is proportional to the level of supersaturation, where supersaturation is the level of solute concentration greater than an equilibrium solubility concentration. Usually the supersaturation level is reported as a ratio of the actual concentration to the solubility concentration at the conditions of the solution. The supersaturation level cannot be directly measured. The supersaturation ratio can be calculated from the solution temperature, solute concentration, and reference solubility value. Prior known methods generally calculate the supersaturation ratio to control the supersaturation level.

Higher temperature also increases growth. Crystal growth increases as the supersaturation level increases until a optimal level of growth is reached. Above this optimal level of growth, new crystals, known as fines, are formed at a cost of growth for existing crystals. This optimal growth rate of sugar crystals is proportional to the surface area on the individual crystals available for deposition of solute. For commercial sugar the crystals should be fairly large and uniformly sized. Therefore, the crystal growth rate should be measured and the crystallizer operated at or below the optimal growth level.

Several factors affect the supersaturation level. The evaporation of water increases the supersaturation level. Precipitation of sucrose from the solution decreases the supersaturation level. Addition of solution to the crystallizer decreases the supersaturation level. Increasing the temperature of the solution decreases the supersaturation level. In the crystallization process, the supersaturation level is controlled by controlling the rate of addition of solution, the rate of evaporation and the temperature of the solution. The temperature is controlled by controlling the pressure/vacuum level. The rate of evaporation is controlled by heat exchange with the calandria, which is dependent on the heat introduced into the calandria and the circulation of the massecuite in the crystallizer. Prior known methods disclose maintaining a constant supersaturation level throughout the growth phase of the crystals. Generally, maintaining a constant supersaturation level throughout the growth phase creates fines during the early stages of crystal growth and less than optimal growth during the later stages of crystal growth.

U.S. Pat. No. 4,155,774 to Randolph discloses a crystallization method that measures supersaturation level, crystal concentration and crystal size distribution (CSD), and controls the supersaturation level in the crystallizer based on the measurements. U.S. Pat. No. 4,263,010 to Randolph discloses a method and apparatus for on-line measurement of crystal population distribution in a crystallizer and control of the growth rate and CSD therefrom. U.S. Pat. No. 4,848,321 to Chigusa discloses a crystallization process that measures consistency (viscosity or fluidity) and controls the crystallization between two curves of consistency over time. U.S. Pat. No. 5,223,040 to de Cremoux discloses a method and apparatus for crystallization with the initial charge and final volume are substantially the same, and brix is measured and supersaturation decreased as brix increases.

Optimizing the crystallization process includes minimizing time and energy use. Many industrial crystallization processes include fines destruction. However, fines destruction increases time and energy use, and should be avoided. An optimal crystallization process grows crystals as quickly as possible without the creation of fines. Such an optimal crystallization process requires homogeneity throughout the solution, in-situ, real time measurement of crystal size, and continuous control of the supersaturation level of the solution.

### DISCLOSURE OF THE INVENTION

Apparatus for crystallization includes a crystallizer with a calandria located near the bottom of the crystallizer. The calandria has a downtake and an extension tube extending upwardly from the downtake. A method for crystallization in a crystallizer includes the steps of feeding an initial charge of a solution of sucrose and water into the crystallizer, then initiating growth of crystals at an initial growth rate, and then growing the crystals at a progressively increasing growth rate according to a growth rate profile or trajectory. The growth is initiated by supersaturating the solution to a selected first level and adding a count,of crystal seed with a known crystal size distribution. The growth rate is increased by increasing the supersaturation level. The crystal size distribution is measured in-situ and the growth rate adjusted based on the crystal size distribution measurements to maintain the same relative crystal size distribution in the crystallizer. The growth rate profile is selected such that the growth rate is proportional to the size of the crystals.

### BRIEF DESCRIPTION OF THE DRAWINGS

Details of this invention are described in connection with the accompanying drawings that bear similar reference numerals in which:

FIG. 1 is a diagrammatic view of a crystallizer embodying features of the present invention.

FIG. 2 is a flow chart of a method embodying features of the present invention.

FIG. 3 is a graphical representation of crystal size distributions of the method of FIG. 2.

### DETAILED DESCRIPTION OF THE INVENTION

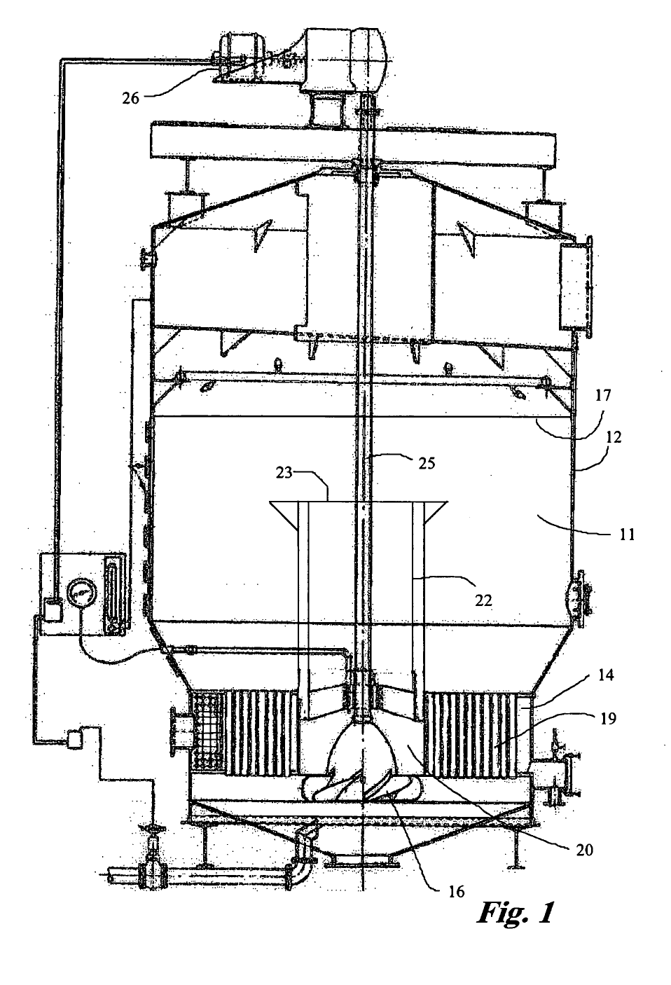

Referring now to FIG. 1, a crystallizer 11 embodying features of the present invention includes a closed tank or vessel 12, a calandria 14 and an impeller 16. The vessel 12 is substantially cylindrical, hollow and has an airtight construction. The final volume level 17 for the vessel 12 is near the top of the vessel 12. The calandria 14 is a heat exchanger located near the bottom of the vessel 12 and spaced downwardly from the final volume level 17. A plurality of solution heating tubes 19 extend upwardly through the calandria 14 around a centrally located downtake 20 that extends downwardly through the calandria 14. A hollow downdraft tube 22 extends upwardly from the downtake 20, having an open top end 23 spaced above the calandria 14 and spaced below the final volume level 17. Preferably the top end 23 of the downdraft tube 22 is spaced about ⅔ of the distance from the calandria 14 to the final volume level 17 above the calandria 14.

The impeller 16 is located below the downtake 20 of the calandria 14 and is connected to a rotary shaft 25. The shaft 25 extends upwardly through the downtake 20 and the downdraft tube 22 to a motor 26 that is mounted on top of the crystallizer 11. Rotation of the impeller 16 by motor 26 through shaft 25 pulls solution down through the downdraft tube 22 and downtake 20. Addition of the downdraft tube 22 improves circulation, and thereby homogeneity, in the crystallizer 11, without the problems associated with the calandria 14 occupying the major volume of the solution, described above.

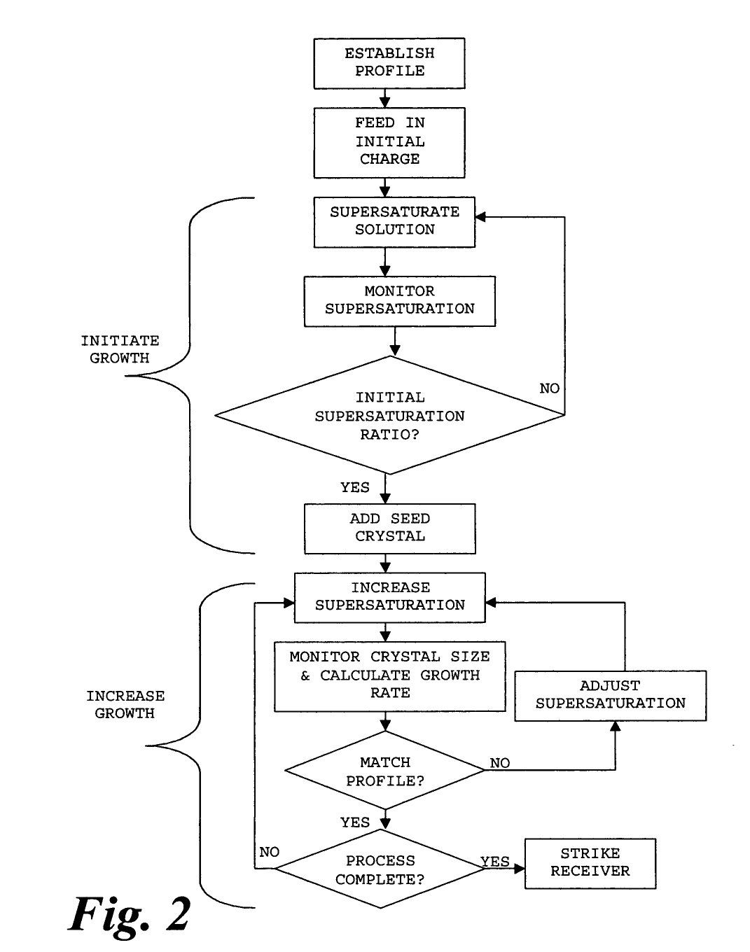

As shown in FIG. 2, a method of crystallization of sugar crystals from a solution of water and sucrose, embodying features of the present invention, includes establishing growth rate profiles, then feeding an initial charge of solution into a crystallizer, then initiating crystal growth in the crystallizer at a selected initial growth level, and then increasing the growth rate progressively over time according to a selected growth rate profile.

Growth rate profiles are established experimentally, due to seasonal changes to impurities in solutions and variations of impurities for plants within a region. Excursions forming new crystals are performed for a plurality of ranges to define the optimal growth rate without fines formation for each range. By way of example, and not as a limitation, appropriate ranges may be log levels such as for crystal lengths of 1-10 microns, 10-100 microns and over 100 microns.

Crystal growth rate is the increase in characteristic length of a crystal over time. The maximum growth rate of a crystal is proportional to the area of the crystal which is proportional to the square of the length. Therefore as the length of a crystal increases, the maximum growth rate will increase at a rate proportional to the square of the length. The rate of increase of the growth rate will not be linear, but will instead be continuously accelerating with the slope of the growth rate profile continuously increasing.

The crystal size distribution represents the variation in size of a crystal population. The growth rate profile represents the relationship between growth rate and a selected characteristic of the crystal size distribution and the predicted values of the selected characteristic of the crystal size distribution over time. To the extent that the crystal size distribution approximates a lognormal distribution, a preferred selected characteristic may be the mean or mode of the crystal size distribution. Establishing the growth rate profiles may not be required for each batch, but may be performed periodically. Accumulation and analysis of growth rate profiles over a period of time may allow prediction of growth rate profiles from the composition of the standard liquor.

After a growth rate profile has been established, the initial charge is fed into the crystallizer. When using the crystallizer 11, described above, the initial charge should be near the final volume level 17. The step of initiating crystal growth in the crystallizer at a selected initial growth level begins with heating, and thereby evaporating, the initial charge to increase the saturation level. The saturation level of the solution is monitored. When a selected initial level of supersaturation is reached, a count of seed crystals will be introduced. The selected initial level of supersaturation represents the initial level for the growth rate, and preferably has a supersaturation ratio of about 1.1 to 1.15.

The count or mass of seed crystals is selected according to the d³ rule: d³ₚ=d³ₛ*Mₚ/Mₛ, where dₚ is the length of the seed crystal, dₛ is the length of the product crystal, Mₚ is the mass of the product magma, and Mₛ is the mass of the seed magma. The crystal size distribution of the seed crystal is measured, and preferably selected, prior to addition to the crystallizer. After the count of seed crystal is added to the crystallizer, the growth rate of the crystals is progressively increased according to the growth rate profile. Specifically, crystal size distribution is periodically or continuously measured in-situ, the current growth rate is calculated, and the supersaturation level is adjusted according to a selected trajectory that provides the selected growth rate profile.

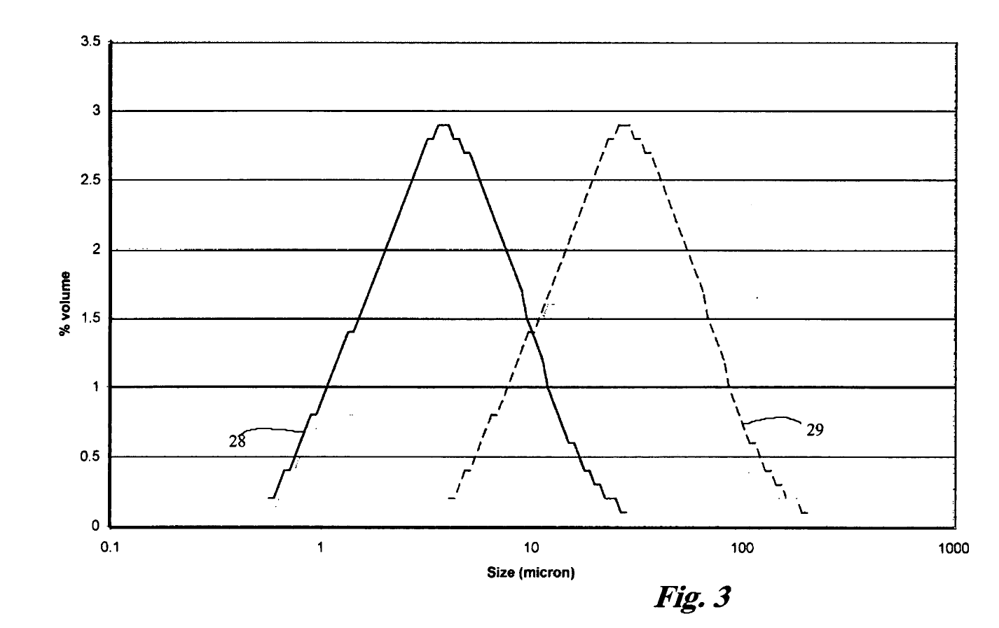

FIG. 3 shows first and second plots 28 and 29 of a crystal size distribution for the above described method. The x axis has a logarithmic scale and represents crystal size. The y axis has a linear scale and represents percent volume. The first and second plots 28 and 29 have shape and size, each having generally a bell shape and therefore approximating a lognormal frequency distribution. The first plot 28 is a plot of the crystal size distribution at a first time and the second plot 29, shifted rightwardly from the first plot 28, is the crystal size distribution at a later time. The method of the present invention maintains the relative crystal size distribution of the seed crystal while translating the crystal size distribution in increasing size. The method of the present invention grows crystals at the optimal growth rate throughout the growth phase, without fines formation, to provide large, relatively uniform crystal in a minimal time with minimal energy use.

Although the present invention has been described with a certain degree of particularity, it is understood that the present disclosure has been made by way of example and that changes in details of structure may be made without departing from the spirit thereof.

What is claimed is:

1. A method for crystallization in a crystallizer comprising the steps of:
feeding an initial charge of a solution of solvent and salute into said crystallizer,
then initiating growth of crystals in said crystallizer at a growth rate having a selected initial level, and then increasing said growth rate progressively over time according to a selected growth rate profile.

2. The method as set forth in claim 1 wherein said step of initiating includes the substeps of:
evaporating said solvent to supersaturate said solution,
controlling and monitoring the level of supersaturation of said solution, and
then adding a count of seed crystals to said crystallizer when said solution reaches a selected initial level of supersaturation.

3. The method as set forth in claim 2 wherein said seed crystals have a selected crystal size distribution.

4. The method as set forth in claim 3 wherein said step of increasing includes translating said crystal size distribution in size over time.

5. The method as set forth in claim 3 wherein said step of increasing includes measuring said crystal size distribution and adjusting supersaturation based on a characteristic length of said crystal size distribution.

6. The method as set forth in claim 1 wherein said solvent is water, said solute is sucrose and said crystals are sugar.

7. The method as set forth in claim 1 wherein said growth rate profile is a function of the rate of increase crystal characteristic length over time and said growth rate is directly proportional to crystal area.

8. The method as set forth in claim 7 wherein said growth rate continuously accelerates in said growth rate profile.

9. The method as set forth in claim 1 including the step of establishing said growth rate profile experimentally before said step of initiating.

10. A method for crystallization in a crystallizer comprising the steps of:
establishing a growth rate profile experimentally,
feeding an initial charge of a solution of water and sucrose into said crystallizer,
then evaporating said solvent to supersaturate said solution,
controlling and monitoring the level of supersaturation of said solution,
then adding a count of sugar seed crystals to said crystallizer when said solution reaches a selected first level of supersaturation, said count having a selected crystal size distribution, said first level of supersaturation initiating crystal growth at a growth rate having a selected initial level and
then increasing said growth rate progressively over time according to a selected growth rate profile by translating said crystal size distribution in size over time, said growth rate continuously accelerating in said growth rate profile.

11. Apparatus for crystallizing crystals from a solution comprising:
a closed hollow vessel having a final volume level for said solution,
a calandria in said vessel and spaced a selected distance below said final volume level, said calandria having a plurality of heating tubes extending upwardly therethrough and a centrally located downtake extending downwardly therethrough, and
a hollow downdraft tube that extends upwardly from said downtake and has an open top end spaced below said final volume level,
whereby circulation and homogeneity of said solution in said vessel is improved.

12. The apparatus as set forth in claim 11 wherein said top end is spaced at about two thirds of said selected distance from said calandria.
